(19) United States
(12) Patent Application Publication
(10) Pub. No.: US 2018/0101044 A1
(43) Pub. Date: Apr. 12, 2018

(54) DISPLAY DEVICE

(71) Applicant: Japan Display Inc., Tokyo (JP)

(72) Inventors: Shinichiro OKA, Tokyo (JP); Toshinari SASAKI, Tokyo (JP)

(21) Appl. No.: 15/708,506

(22) Filed: Sep. 19, 2017

(30) Foreign Application Priority Data
Oct. 6, 2016 (JP) 2016-198287

(51) Int. Cl. G02F 1/1333; G02F 1/1339; G02F 1/133; G02F 1/1345; G02F 1/1335

(52) U.S. Cl. CPC G02F 1/133305; G02F 1/1339; G02F 1/133528; G02F 1/1345; G02F 1/13452; G02F 1/13306

(57) ABSTRACT

A display device includes a flexible first substrate, a flexible second substrate facing the first substrate, a liquid crystal layer between the first substrate and the second substrate, a sealing member sealing the liquid crystal layer between the first substrate and the second substrate, a first optical member bonded to the first substrate, a terminal section on the first substrate, the terminal section being in a region not overlapping the second substrate, a driving circuit substrate connected with the terminal section, and a second optical member or a resin member, the terminal section being between the first optical member and the second optical member or between the first optical member and the resin member.

### CROSS REFERENCE TO RELATED APPLICATIONS

This application is based upon and claims the benefit of priority from the prior Japanese Patent Application No. 2016-198287 filed on Oct. 6, 2016, the entire contents of which are incorporated herein by reference.

### FIELD

The present invention relates to a display device, and specifically, to a liquid crystal display device including a flexible substrate.

### BACKGROUND

A flexible display is expected to be used in a wide range from a mobile foldable display to a large screen display. A flexible display is strongly desired to be realized as a next-generation display that is lightweight and is easily accommodated. Especially, a liquid crystal display element is applicable to both of a transmission-type display system and a reflection-type display system, and thus has a possibility of being applied to a flexible display that provides superb visible recognizability in any of various illumination environments.

In the case of being used for a display section of a flexible display, a liquid crystal display device needs to include a flexible substrate. Usually, a resin substrate having a thickness of 50 μm or less is used as such a flexible substrate. However, a liquid crystal display device including a flexible substrate having such a thickness is distorted in an unintended manner due to the weight thereof. In order to suppress the distortion of the liquid crystal display device, the flexible substrate needs to be reinforced. Japanese Laid-Open Patent Publication No. 2011-47975 discloses a display device in which an array substrate and a counter substrate each have a polarizer plate bonded thereto in a display region. The array substrate is a substrate having a transistor provided thereon. The counter substrate is a substrate facing the array substrate. The display region of the display device described in Japanese Laid-Open Patent Publication No. 2011-47975 is reinforced by the polarizer plates attached to the array substrate and the counter substrate.

However, in the display device described in Japanese Laid-Open Patent Publication No. 2011-47975, a terminal section, on the array substrate, on which an FPC (Flexible Printed Circuit) and the like are provided, is exposed from the counter substrate. Therefore, the terminal section does not have a sufficient strength. The display device described in Japanese Laid-Open Patent Publication No. 2011-47975 has a problem of being distorted and destroyed when an external force is applied to the terminal section. Namely, such a conventional display device has a problem of having a low reliability in terms of the load resistance characteristics.

### SUMMARY

A display device in an embodiment according to the present invention includes a flexible first substrate, a flexible second substrate facing the first substrate, a liquid crystal layer between the first substrate and the second substrate, a sealing member sealing the liquid crystal layer between the first substrate and the second substrate, a first optical member bonded to the first substrate, a terminal section on the first substrate, the terminal section being in a region not overlapping the second substrate, a driving circuit substrate connected with the terminal section, and a second optical member or a resin member, the terminal section being between the first optical member and the second optical member or between the first optical member and the resin member.

### BRIEF DESCRIPTION OF DRAWINGS

FIG. 1 is a structural view of a liquid crystal device in an embodiment according to the present invention;

FIG. 2 is a plan view showing an overall structure of a liquid crystal display device in an embodiment according to the present invention;

FIG. 3 is a cross-sectional view of the liquid crystal device in an embodiment according to the present invention;

FIG. 4A is a cross-sectional view showing a step of forming an array substrate on a support substrate in a method for producing the liquid crystal device in an embodiment according to the present invention;

FIG. 4B is a cross-sectional view showing a step of forming a liquid crystal layer and a counter substrate in the method for producing the liquid crystal device in an embodiment according to the present invention;

FIG. 4C is a cross-sectional view showing a step of mounting an IC chip and an FPC on a terminal section in the method for producing the liquid crystal device in an embodiment according to the present invention;

FIG. 4D is a cross-sectional view showing a step of forming a resin member on the terminal section in the method for producing the liquid crystal device in an embodiment according to the present invention;

FIG. 4E is a cross-sectional view showing a step of bonding a polarizer plate to the counter substrate in the method for producing the liquid crystal device in an embodiment according to the present invention;

FIG. 4F is a cross-sectional view showing a step of peeling off the support substrate from the array substrate in the method for producing the liquid crystal device in an embodiment according to the present invention;

FIG. 5 is a cross-sectional view showing an overall structure of a liquid crystal device in an embodiment according to the present invention;

FIG. 6A is a cross-sectional view showing an overall structure of a liquid crystal device in an embodiment according to the present invention;

FIG. 6B is a cross-sectional view showing an overall structure of a liquid crystal device in an embodiment according to the present invention;

FIG. 7 is a cross-sectional view showing an overall structure of a liquid crystal device in an embodiment according to the present invention;

FIG. 8 is a general view of electrodes for a touch sensor in a touch sensor-attached liquid crystal device of an electrostatic capacitance type in an embodiment according to the present invention;

FIG. 9 shows a layout of touch detection electrodes in the touch sensor-attached liquid crystal device in an embodiment according to the present invention;

FIG. 10 is a cross-sectional view of the touch sensor-attached liquid crystal device in an embodiment according to the present invention, taken along line B-B′ in FIG. 9;

FIG. 11 is a general view of electrodes for a touch sensor in a touch sensor-attached liquid crystal device in an embodiment according to the present invention;

FIG. 12 is a general view of electrodes for a touch sensor in a touch sensor-attached liquid crystal device in an embodiment according to the present invention;

FIG. 13 shows an example of electronic device including a liquid crystal device in an embodiment according to the present invention; and

FIG. 14 shows an example of electronic device including a liquid crystal device in an embodiment according to the present invention.

### DESCRIPTION OF EMBODIMENTS

Hereinafter, embodiments of the present invention will be described with reference to the drawings. The disclosure merely provides examples, and alternations and modifications easily conceivable by a person of ordinary skill in the art without departing from the gist of the present invention are duly encompassed in the scope of the present invention. In the drawings, components may be shown schematically regarding the width, thickness, shape and the like, instead of being shown in accordance with the actual sizes, for the sake of clear illustration. The drawings merely show examples and do not limit the interpretations of the present invention in any way. In the specification and the drawings, components that are substantially the same as those shown in a previous drawing(s) bear the identical reference signs with alphabetical letters, and detailed descriptions thereof may be omitted.

In the embodiments of the present invention, a direction from an array substrate, having a transistor provided thereon, toward a counter substrate facing the array substrate is referred to as “upward”. By contrast, a direction from the counter substrate toward the array substrate is referred to as “downward”. For the sake of explanation, the term “up”, “down”, “above”, “below” or the like may be used to describe a direction in this manner. However, for example, the array substrate and the counter substrate may be located so as to have an opposite positional relationship in the up-down direction. In the following description, an expression “a counter substrate on an array substrate”, for example, merely describes a positional relationship between the array substrate and the counter substrate in the up-down direction. The expression represents a concept encompassing a case where another component is provided between the array substrate and the counter substrate. The following embodiments have an object of providing a highly reliable display device.

### Embodiment 1

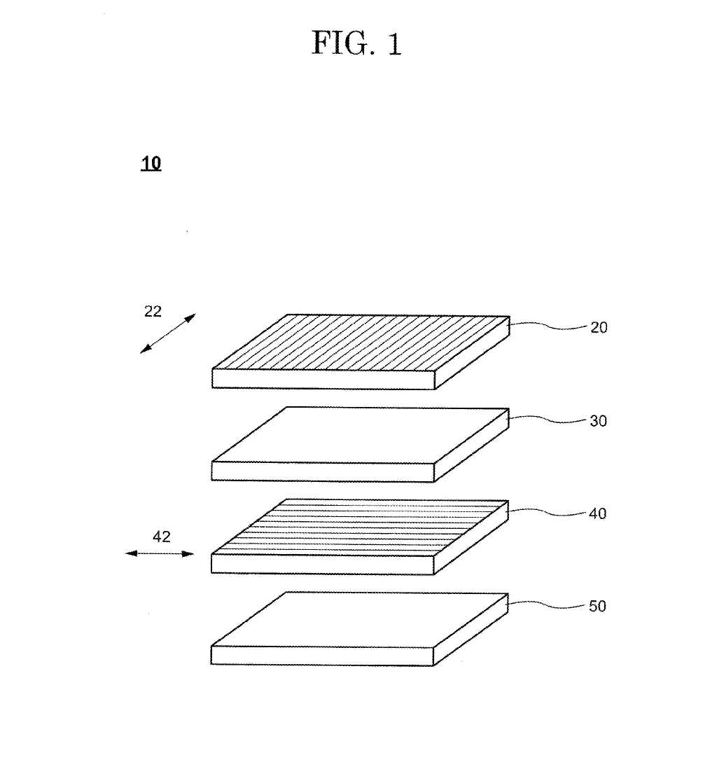

With reference to FIG. 1 through FIG. 4F, an overview of a liquid crystal device in an embodiment according to the present invention will be described. In embodiment 1, a liquid crystal display (LCD) device is used as the display device. Especially, a structure of a terminal section and the vicinity thereof of the liquid crystal device will be described. In the following embodiments, a liquid crystal device will be described, but the present invention is applicable to an organic EL device (Organic Light Emitting Diode: OLED), an electronic paper-type display device and the like in addition to a liquid crystal display device.

### [Structure of the Liquid Crystal Device 10]

FIG. 1 is a structural view of a liquid crystal device 10 in embodiment 1 according to the present invention. As shown in FIG. 1, the liquid crystal device 10 in this embodiment includes a liquid crystal display device 30, a first polarizer plate 40, a second polarizer plate 20, and a backlight unit 50. The liquid crystal display device 30 is located between the first polarizer plate 40 and the second polarizer plate 20. A polarization axis 42 of the first polarizer plate 40 is perpendicular to a polarization axis 22 of the second polarizer plate 20. It should be noted that the polarization axis 42 and the polarization axis 22 may cross each other at an angle other than 90 degrees, or may be parallel to each other. The backlight unit 50 is located on the side opposite to the liquid crystal display device 30 with respect to the first polarizer plate 40. The backlight unit 50 is located outer to a pair of polarizer plates (first polarizer plate 40 and second polarizer plate 20) and on the side opposite to the side where a user visually recognizes a displayed video.

The first polarizer plate 40 and the second polarizer plate 20 each transmit light polarized in a specific direction. The second polarizer plate 20 has an optical function of absorbing light polarized in a direction perpendicular to the polarization direction of light transmitted through the first polarizer plate 40. The first polarizer plate 40 and the second polarizer plate 20 are respectively located on two sides of the liquid crystal display device 30 such that the polarization directions thereof are perpendicular to each other. Such a positional arrangement allows display to be provided by use of an optical shutter effect. The first polarizer plate 40 and the second polarizer plate 20 may each have, for example, a multi-layer structure. Such a multi-layer structure includes a poly(vinylalcohol) (PVA) main portion, iodine compound molecules adsorbed, in an aligned manner, to the poly(vinylalcohol) (PVA) main portion, and a plurality of liner layers formed of triacetylcellulose (TAC), polyethyleneterephthalate (PET) or the like acting as protective layers.

The backlight unit 50 is a light source providing light from the rear side of the liquid crystal display device 30 toward the liquid crystal display device 30. The backlight unit 50 is a uniform planar light source. The backlight unit 50 includes a light emission source, a light guide plate, a reflective sheet, a diffusive sheet, and a prism sheet. The backlight unit 50 is generally available in an edge light type or a direct type. With an edge light-type backlight unit, a light emission source such as an LED or the like is located only at an edge of the liquid crystal display device 30, not on a rear surface thereof. Light emitted from the light emission source is guided to the entirety of the screen of the liquid crystal display device 30 by components such as the light guide plate, the reflective sheet, the diffusive sheet, the prism sheet and the like having a light collection function or a light diffusion function. With a direct-type backlight unit, a light emission source such as an LED or the like is located just below the liquid crystal display device 30.

### [Planar Layout of the Liquid Crystal Display Device 30]

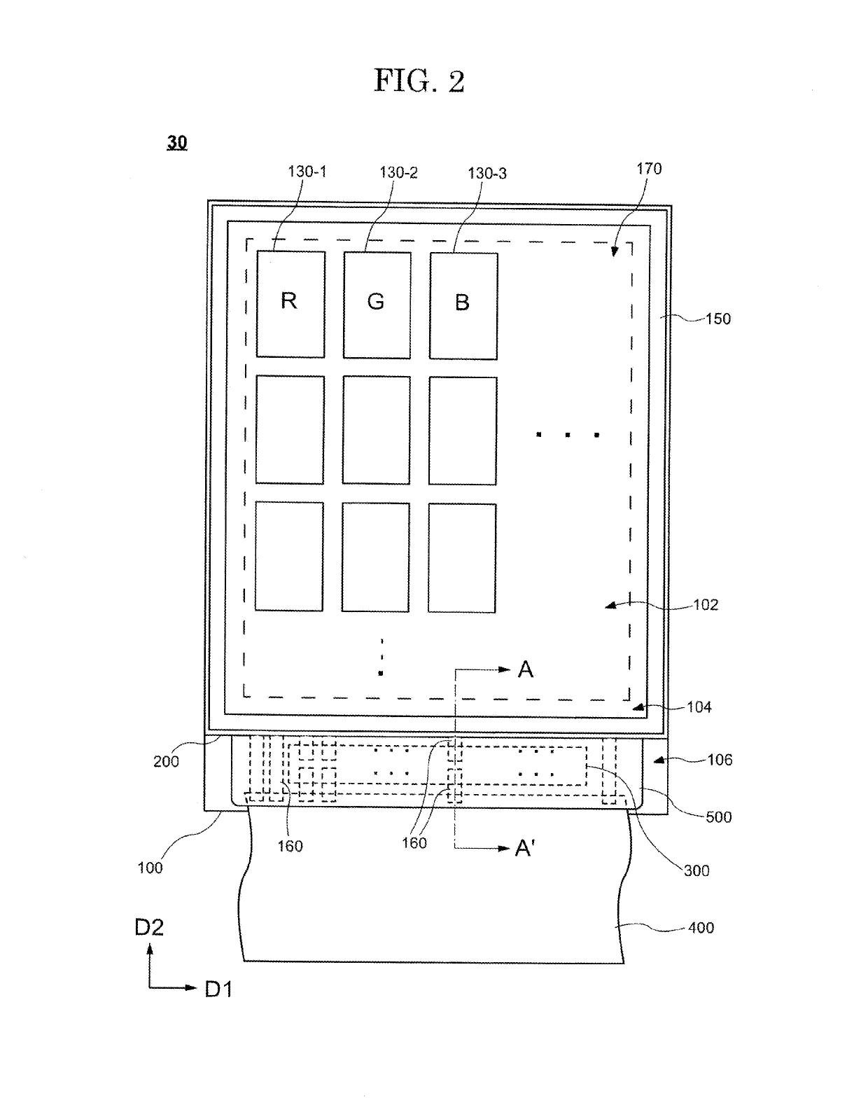

FIG. 2 is a plan view showing an overall structure of the liquid crystal display device 30 in embodiment 1 according to the present invention. FIG. 2 shows the liquid crystal display device 30 but does not show optical members such as the first polarizer plate 40, the second polarizer plate 20, the backlight unit 50 and the like for ease of explanation. As shown in FIG. 2, the liquid crystal display device 30 includes an array substrate 100, a counter substrate 200, an IC chip 300, an FPC (flexible printed circuit as a driving circuit substrate) 400, and a resin member 500. A pixel for a single color used to realize full color display is referred to as a “sub pixel”, and a minimum unit of sub pixels realizing full color display or white display is referred to as a “main pixel”. In the description of the embodiments in this specification, the “pixel” refers to a sub pixel unless otherwise specified.

The array substrate 100 has a plurality of pixels 130 located thereon in a matrix. In the example shown in FIG. 2, one main pixel includes an R pixel 130-1 displaying red, a G pixel 130-2 displaying green, and a B pixel 130-3 displaying blue (in the case where the pixels 130-1, 130-2 and 130-3 are not specifically distinguished from each other, these sub pixels will each be referred to as a “pixel”). The pixels 130 include pixel electrodes and a common electrode. Each of the pixel electrodes and the common electrode generate an electric field that controls the alignment of liquid crystal molecules. Such a pixel electrode is located in each of the pixels 130. The common electrode is located commonly for a plurality of pixels 130.

The pixel electrodes and the common electrode may be arranged as follows. For example, the pixel electrodes and the common electrode may be both located on the array substrate 100, so that a lateral electric field is generated in a liquid crystal layer. Alternatively, the pixel electrodes may be located on the array substrate 100 and the common electrode may be located on the counter substrate 200, so that a vertical electric field is generated in the liquid crystal layer. The main pixel is not limited to having the above-described structure, and may have any of various structures. For example, the main pixel may include four sub pixels, namely, red, green, blue and white sub pixels.

A region of the array substrate 100 on which the above-described pixels 130 are provided is referred to as a “display region 102”. A region around the display region 102 is referred to as a peripheral region 104. On the peripheral region 104, a driving circuit (not shown) controlling the voltage to be applied to the pixel electrode included in each of the pixels 130 is located. An end region of the peripheral region 104 is referred to as a “driving region 106”. In the driving region 106, the array substrate 100 is exposed from the counter substrate 200. On the driving region 106 of the array substrate 100, terminal sections 160, the IC chip 300, and the FPC 400 are located. The resin member 500 covers the terminal sections 160, the IC chip 300 and a part of the FPC 400. The resin member 500 is continuously located from an end of the counter substrate 200 to the part of the FPC 400. The resin member 500 covers both of two ends of the FPC 400 in a direction D1. Namely, the resin member 500 has a width in the direction D1 that is greater than a width of the FPC 400 in the direction D1. Although the driving region 106 is a part of the array substrate 10, in the following description, the term “driving region” also refers to a region of the liquid crystal device (e.g., liquid crystal device 10) in positional correspondence with the driving region of the array substrate (e.g., array substrate 100).

In the example of FIG. 2, the resin member 500 covers the entirety of the plurality of terminal sections 160 arrayed side by side in the direction D1 and the entirety of the IC chip 300, and also covers both of the two ends of the FPC 400 in the direction D1. The liquid crystal device 10 is not limited to having such a structure. For example, a part of the plurality of terminal sections 160 may be exposed from the resin member 500. A part of the IC chip 300 may be exposed from the resin member 500. The resin member 500 may be shaped to cover each of the terminal sections 160 separately. Namely, a plurality of the resin members 500 may be provided in correspondence with the plurality of terminal sections 160. In this case, each of the resin members 500 may have a longitudinal direction in a direction D2 along the planar shape of the terminal sections 160. Both of the two ends of the FPC 400 in the direction D1 may be exposed from the resin member 500. Namely, the width of the resin member 500 in the D1 direction may be smaller than the width of the FPC 400 in the direction D1.

The IC chip 300 is mounted on the array substrate 100 via a bump or the like. For example, the IC chip 300 may be mounted by a method of COG (Chip On Glass) or the like. For example, the IC chip 300 is connected with the terminal sections 160 formed on the array substrate 100 and is connected with the driving circuit located on the peripheral region 104 via the terminal sections 160. The FPC 400 is mounted on the terminal sections 160 via an anisotropic conductive film or the like. The FPC 400 is electrically connected with the IC chip 300, and transmits a video signal (or a gray scale signal) supplied from an external device to the IC chip 300.

Based on the video signal input to the IC chip 300, the driving circuit located on the peripheral region 104 is driven. The driving circuit is thus driven to supply the video signal to the pixel electrode in each of the pixels 130 located in the display region 102, and an image based on the video signal is displayed in the display region 102.

The array substrate 100 and the counter substrate 200 are bonded together with a sealing member 150. The sealing member 150 is formed along an outer periphery of the counter substrate 200. The array substrate 100, the counter substrate 200 and the sealing member 150 enclose a space to be filled with a liquid crystal layer 170 in a sealed manner. The sealing member 150 is located inner to an outer peripheral edge of the counter substrate 200. Namely, as seen in a plan view, the entirety of the sealing member 150 overlaps both of the array substrate 100 and the counter substrate 200. In the following description, a state where two components overlap each other as seen in a plan view will be referred to simply as “overlap”.

### [Cross-Sectional View of the Liquid Crystal Device 10]

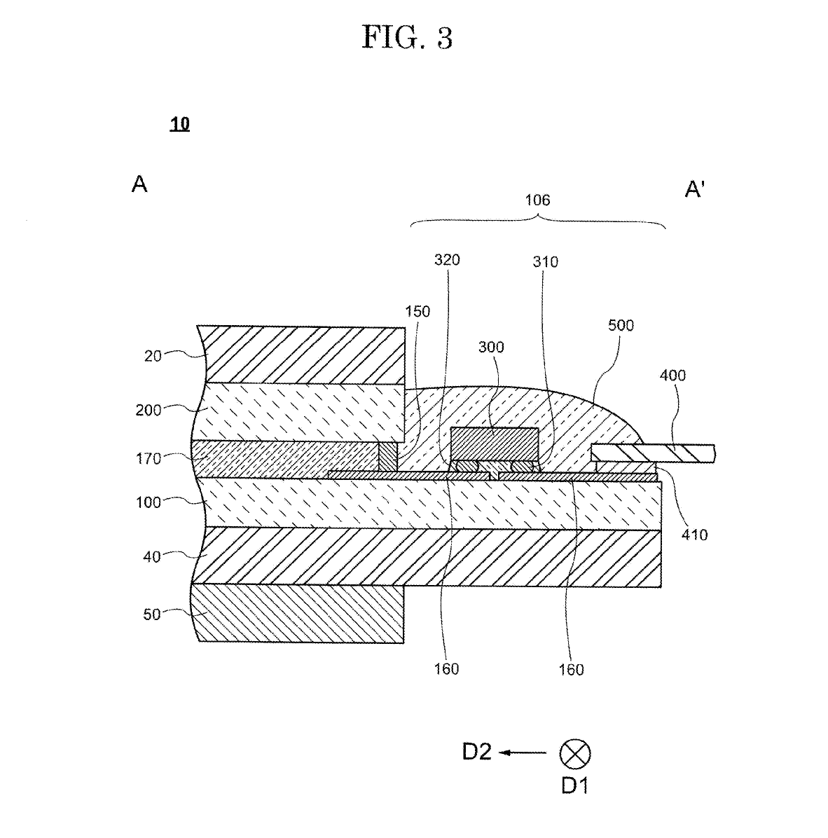

FIG. 3 is a cross-sectional view of the liquid crystal device 10 in embodiment 1 according to the present invention. As shown in FIG. 3, the liquid crystal device 10 includes the backlight unit 50, the first polarizer plate 40, the array substrate 100, the sealing member 150, the liquid crystal layer 170, the counter substrate 200, the second polarizer plate 20, the IC chip 300, the FPC 400, and the resin member 500. The backlight unit 50, the first polarizer plate 40 and the second polarizer plate 20 may each be referred to as an “optical member”. For example, the first polarizer plate 40 may be referred to as a “first optical member”, and the second polarizer plate 20 may be referred to as a “second optical member”. The first optical member may include the backlight unit 50. The cross-sectional view in FIG. 3 is taken along line A-A′ in FIG. 2.

The array substrate 100 and the counter substrate 200 are located to face each other. The sealing member 150 and the liquid crystal layer 170 are located between the array substrate 100 and the counter substrate 200. The liquid crystal layer 170 is surrounded by the sealing member 150. In other words, the liquid crystal layer 170 is enclosed or sealed by the array substrate 100, the counter substrate 200 and the sealing member 150. On the array substrate 100, transistors and lines (not shown) are located. The terminal sections 160 are a part of the lines. The transistors and the lines are located in a region overlapping the sealing member 150 and the liquid crystal layer 170 (namely, on the display region 102 and the peripheral region 104). The terminal sections 160 are located in the driving region 106. One of the two terminal sections 160 shown in FIG. 3 extends from the driving region 106 to cross the sealing member 150 and is connected with the transistors located in the region surrounded by the sealing member 150. The terminal sections 160 electrically connect the transistors with the IC chip 300 and the FPC 400.

The first polarizer plate 40 is bonded to a bottom surface of the array substrate 100 with an adhesive or the like. The backlight unit 50 is bonded to a bottom surface of the first polarizer plate 40 with an adhesive or the like. In other words, the first polarizer plate 40 and the backlight unit 50 are located on the side opposite to the counter substrate 200 with respect to the array substrate 100, in the order of the first polarizer plate 40 and the backlight unit 50. The second polarizer plate 20 is bonded to a top surface of the counter substrate 200 with an adhesive or the like. In other words, the second polarizer plate 20 is located on the side opposite to the array substrate 100 with respect to the counter substrate 200. The first polarizer plate 40 and the second polarizer plate 20 are both a sheet-like polarizer plate having a generally uniform thickness.

The IC chip 300, the FPC 400 and the resin member 500 are located above the array substrate 100 in the driving region 106, which is exposed from the counter substrate 200. Specifically, the IC chip 300 is located on the terminal sections 160 via conductive bumps 310 and an adhesive 320. One of the two terminal sections 160 shown in FIG. 3 that is connected with the FPC 400 is connected with an input terminal of the IC chip 300 via the bump 310. The terminal section 160 connected with the transistors located in the region surrounded by the sealing member 150 is connected with an output terminal of the IC chip 300 via the bump 310. Like the IC chip 300, the FPC 400 is connected with the terminal section 160 via an anisotropic conductive film 410. In the example of FIG. 3, the FPC 400 and the input terminal of the IC chip 300 are connected with each other, and the output terminal of the IC chip 300 and the transistors are connected with each other. The liquid crystal device 10 is not limited to having such a structure. For example, the FPC 400 and the transistors may be connected with each other, not via the IC chip 300.

The resin member 500 is located on the array substrate 100, the IC chip 300 and the FPC 400. The resin member 500 covers the terminal sections 160 and the IC chip 300 and also covers a part of the FPC 400. The resin member 500 is in contact with a side surface of the counter substrate 200. The resin member 500 is continuously located from the side surface of the counter substrate 200 to the part of the FPC 400 while covering the IC chip 300. The resin member 500 covers ends of the adhesive 320 located between the array substrate 100 and the IC chip 300. Similarly, the resin member 500 covers an end of the anisotropic conductive film 410 located between the array substrate 100 and the FPC 400. In other words, the resin member 500 holds the terminal sections 160 together with the first polarizer plate 40.

In the example of FIG. 3, the resin member 500 is not in contact with the second polarizer plate 20, and a part of the counter substrate 200 is exposed from the resin member 500. The liquid crystal device 10 is not limited to having such a structure. For example, the resin member 500 may cover the side surface of the counter substrate 200 and contact a side surface of the second polarizer plate 20. In the example of FIG. 3, the adhesive 320 is located around the bumps 310, and a space between the array substrate 100 and the IC chip 300 is filled with the adhesive 320. The liquid crystal device 10 is not limited to having such a structure. For example, the bumps 310 not surrounded by the adhesive 320 may be located between the array substrate 100 and the IC chip 300. In this case, a space may be provided between the array substrate 100 and the IC chip 300. Alternatively, the resin member 500 may fill the space between the array substrate 100 and the IC chip 300.

The first polarizer plate 40 has an end thereof at a position that is approximately the same as the position of an end of the array substrate 100. Namely, as shown in FIG. 2 and FIG. 3, the sealing member 150, the terminal sections 160, the liquid crystal layer 170, the IC chip 300 and a part of the FPC 400 (region having the anisotropic conductive film 410 formed thereon) overlap the first polarizer plate 40. In other words, the terminal sections 160 overlap the first polarizer plate 40 and the resin member 500. The second polarizer plate 20 has an end thereof at a position that is approximately the same as the position of an end of the counter substrate 200. Namely, as shown in FIG. 2 and FIG. 3, the sealing member 150 and the liquid crystal layer 170 overlap the second polarizer plate 20.

In the example of FIG. 3, the position of the end of the first polarizer plate 40 and the position of the end of the array substrate 100 are approximately the same as each other. The liquid crystal device 10 is not limited to having such a structure. For example, the first polarizer plate 40 may have an area size smaller than that of the array substrate 100 as seen in a plan view. Namely, the position of the end of the first polarizer plate 40 may be inner to (i.e., closer to the center of the array substrate 100 than) the position of the end of the array substrate 100. Similarly, the second polarizer plate 20 may have an area size smaller than that of the counter substrate 200 as seen in a plan view. Namely, the position of the end of the second polarizer plate 20 may be inner to (i.e., closer to the center of the counter substrate 200 than) the position of the end of the counter substrate 200. In the example of FIG. 3, the backlight unit 50 has an end thereof at a position that is approximately the same as the position of an end of the counter substrate 200. The liquid crystal device 100 is not limited to having such a structure. For example, the backlight unit 50 may extend to the driving region 106. Namely, the position of the end of the backlight unit 50 may be approximately the same as the position of the end of the first polarizer plate 40.

### [Materials of the Components]

The array substrate 100 and the counter substrate 200 may each be a substrate that is flexible and visible light-transmissive. For example, the array substrate 100 and the counter substrate 200 may each be a resin substrate. Such a resin substrate may be formed of polyimide resin, acrylic resin, epoxy resin, silicone resin, fluorine resin, siloxane resin, polyethyleneterephthalate resin, polyethylenenaphthalate resin, polyacrylonitrile resin, polymethylmethacrylate resin, polycarbonate resin, polyethersulfone resin, polyamide resin, cycloolefin resin, polystyrene resin, polyamideimide resin, polyvinylchloride resin, or the like. Among these resins, polyimide resin is preferable as the material of the array substrate 100 and the counter substrate 200. The array substrate 100 and the counter substrate 200 may be formed of the same material as, or different materials from, each other.

It is preferable that the resin member 500 is formed of polyimide resin, acrylic resin, epoxy resin, silicone resin, fluorine resin, siloxane resin, polyethyleneterephthalate resin, polyethylenenaphthalate resin, polyacrylonitrile resin, polymethylmethacrylate resin, polycarbonate resin, polyethersulfone resin, polyamide resin, cycloolefin resin, polystyrene resin, polyamideimide resin, polyvinylchloride resin, or the like. Among these resins, acrylic resin or epoxy resin is preferable as the material of the resin member 500.

As described above, in the liquid crystal device 10 in embodiment 1, the array substrate 100 in the driving region 106 is reinforced, on the side of the first polarizer plate 40, by the first polarizer plate 40, and is reinforced, on the side of the second polarizer plate 20, by the resin member 500. Therefore, even if being supplied with an external force, the liquid crystal device 10 is suppressed from being distorted in the driving region 106 more than in the other regions. As a result, the liquid crystal device 10 is highly reliable in terms of the load resistance characteristics.

### [Method for Producing the Liquid Crystal Display Device 30]

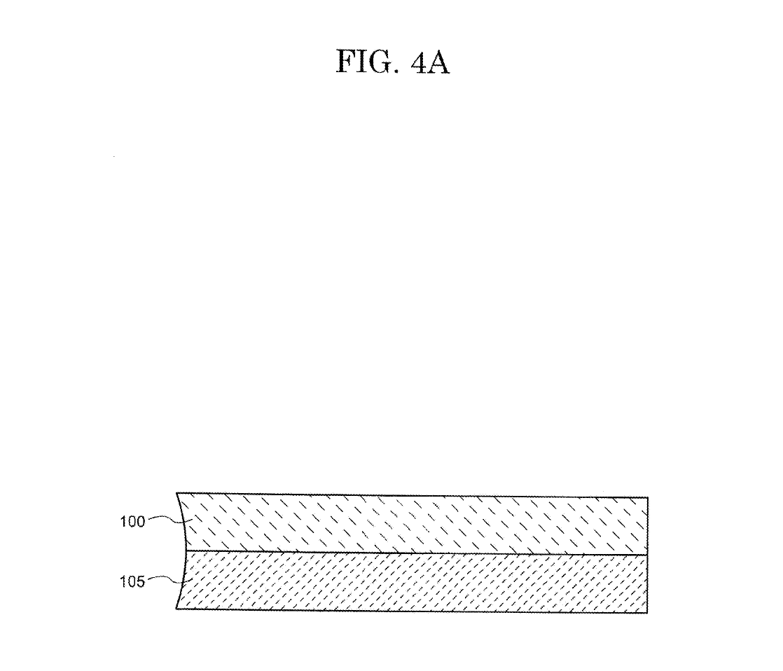

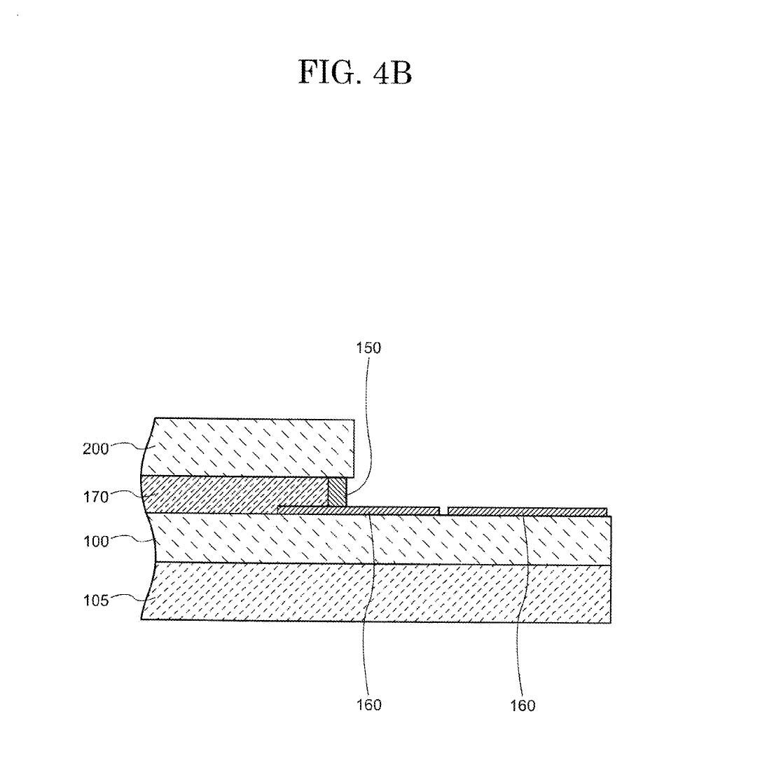

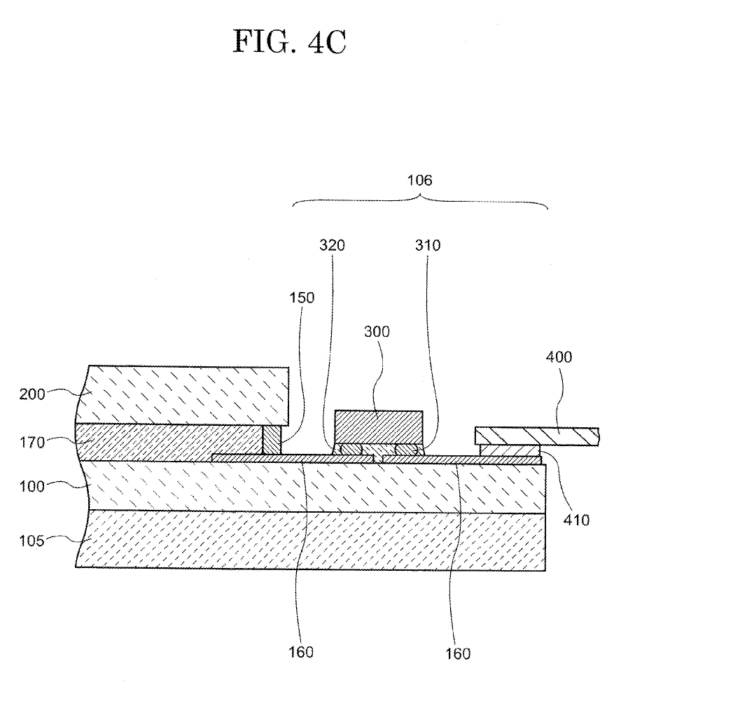

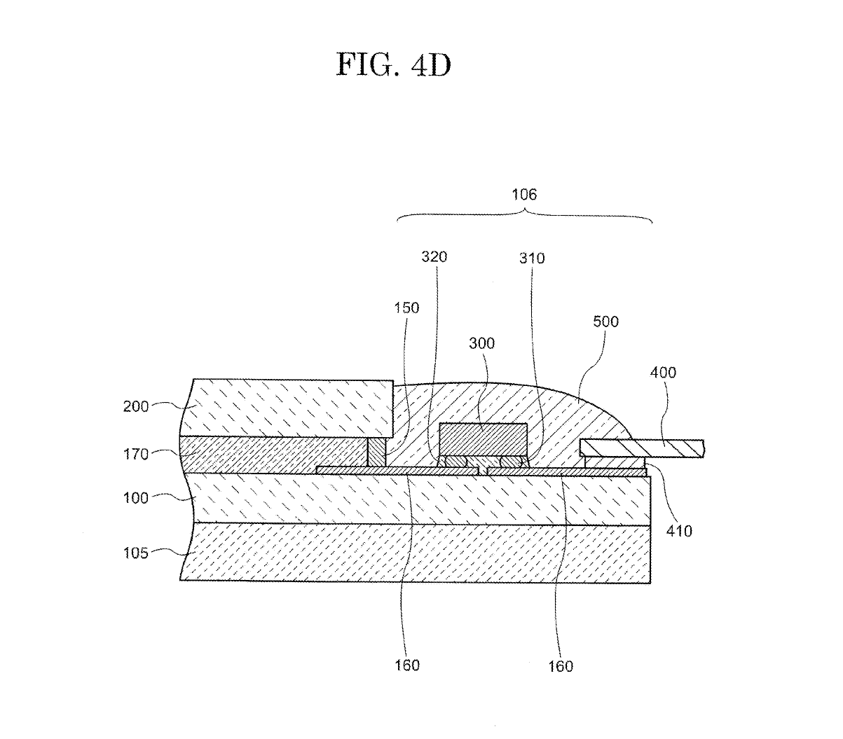

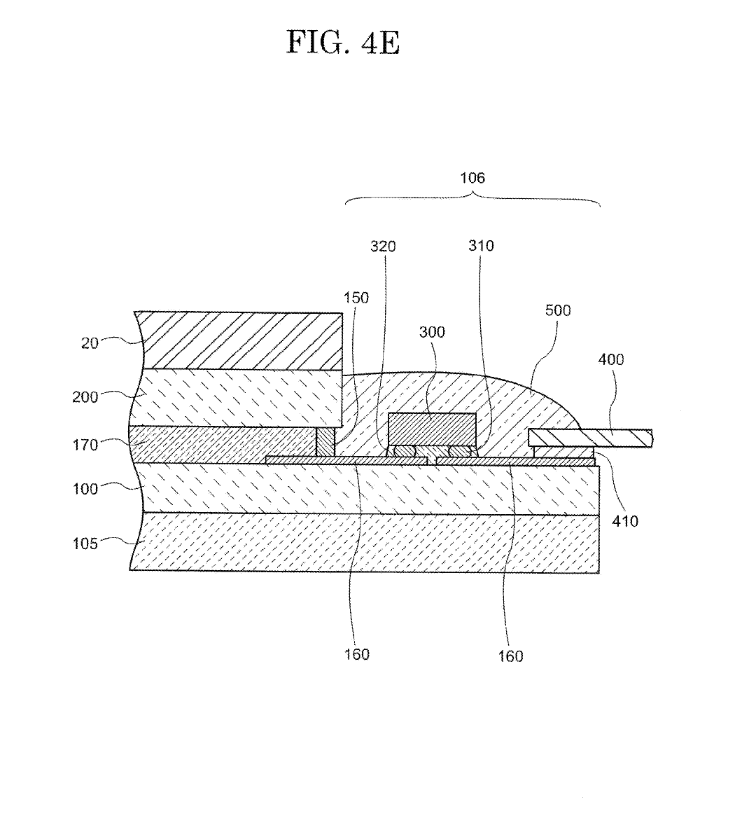

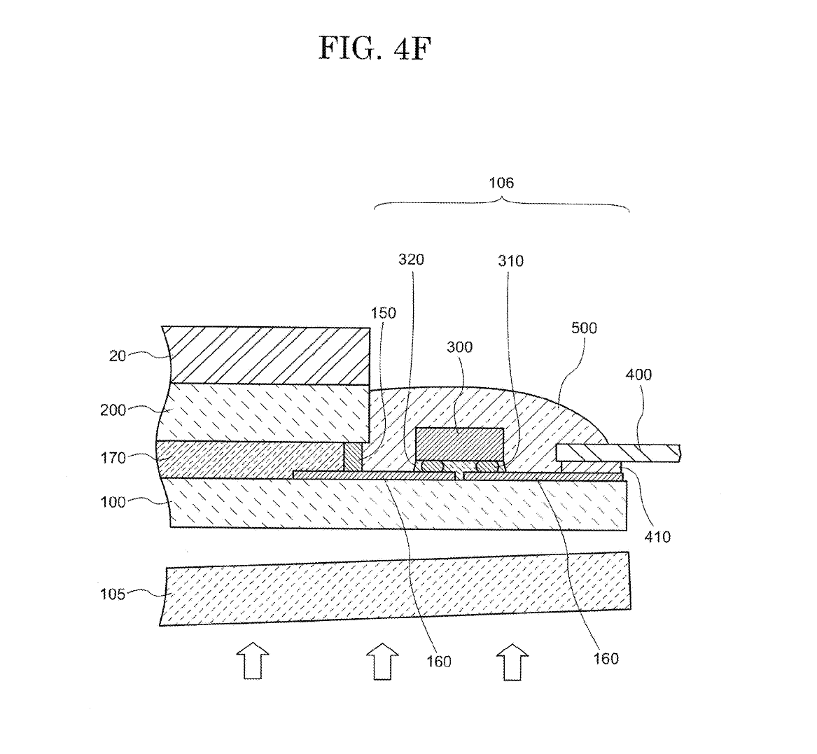

With reference to cross-sectional views in FIG. 4A through FIG. 4F, a method for producing the liquid crystal device 10 will be described. With the method in this example, the liquid crystal display device 30 is formed on a support substrate and is peeled off from the support substrate, and then the first polarizer plate 40, the second polarizer plate 20 and the backlight unit 50 are attached.

FIG. 4A is a cross-sectional view showing a step of forming the array substrate 100 on a support substrate 105 in the method for producing the liquid crystal device 10 in embodiment 1 according to the present invention. As shown in FIG. 4A, the array substrate 100 is formed on the support substrate 105. The support substrate 105 has a sufficient rigidity and a sufficient heat resistance for a step of producing the transistors. The support substrate 105 may be, for example, a glass substrate, a quartz substrate, a silicon substrate, a sapphire substrate or the like. The array substrate 100 is formed by an application method. For example, while the support substrate 105 is rotated, a solution containing a resin material used to form the array substrate 100 dissolved therein is applied to the support substrate 105, and the solvent is vaporized by heat treatment. Thus, the array substrate 100 is formed. The array substrate 100 may be formed by an application method by use of a slit coater, a dip method or the like instead of the above-described application method.

The array substrate 100 needs to have a thickness with which after the liquid crystal display device 30 is peeled off from the support substrate 105, namely, after the liquid crystal display device 30 is made flexible, the performance of the liquid crystal display device 30 is maintained. For example, the thickness of the array substrate 100 may be 3.0 μm or greater and 50.0 μm or less. Preferably, the thickness of the array substrate 100 may be, for example, 5.0 μm or greater and 20.0 μm or less. In the case there the thickness of the array substrate 100 is smaller than the lower limit, the strength of the liquid crystal display device 30 is decreased, and thus the performance of the liquid crystal display device 30 is not maintained after the liquid crystal display device 30 is made flexible. In the case where the thickness of the array substrate 100 is larger than the upper limit, the liquid crystal display device 30 is not made sufficiently flexible.

FIG. 4B is a cross-sectional view showing a step of forming the liquid crystal layer 170 and the counter substrate 200 in the method for producing the liquid crystal device 10 in embodiment 1 according to the present invention. On the array substrate 100, transistor elements, capacitance elements, lines including the terminal sections 160 and the like are formed. Next, the sealing member 150, having an injection opening through which a liquid crystal material is to be injected in a later step, is formed, and the array substrate 100 and the counter substrate 200 are bonded to each other. The liquid crystal material is injected through the injection opening in the sealing member 150, and the injection opening is closed. As a result of this step, the liquid crystal layer 170 is formed.

In the above-described example, after the array substrate 100 and the counter substrate 200 are bonded together, the liquid crystal material is injected through the injection opening to form the liquid crystal layer 170. The method for producing the liquid crystal device 10 is not limited to this. For example, the liquid crystal layer 170 may be injected by an ODF (One Drop Fill) method. The ODF method is carried out as follows. Before the array substrate 100 and the counter substrate 200 are bonded together, the liquid crystal material is dropped onto the array substrate 100 or the counter substrate 200 in a vacuum atmosphere or a reduced pressure atmosphere, and then the array substrate 100 and the counter substrate 200 are bonded together.

FIG. 4C is a cross-sectional view showing a step of forming the IC chip 300 and the FPC 400 on the terminal sections 160 in the method for producing the liquid crystal device 10 in embodiment 1 according to the present invention. As shown in FIG. 4C, the IC chip 300 and the FPC 400 are mounted on the terminal sections 160 exposed, in the driving region 106, from the counter substrate 200. The IC chip 300 is attached to the terminal sections 160 with the bumps 310 and the adhesive 320. The FPC 400 is attached to the terminal section 160 with the anisotropic conductive film 410. The IC chip 300 may be attached to the terminal sections 160 with an anisotropic conductive film instead of the bumps 310 and the adhesive 320.

FIG. 4D is a cross-sectional view showing a step of forming the resin member 500 on the terminal sections 160 in the method for producing the liquid crystal device 10 in embodiment 1 according to the present invention. As shown in FIG. 4D, the resin member 500 is formed to cover the terminal sections 160, the IC chip 300 and a part of the FPC 400. The resin member 500 is continuously formed from the end of the counter substrate 200 to the part of the FPC 400. It is preferable that the resin member 500 has a height smaller than the total height of the liquid crystal layer 170, the counter substrate 200 and the second polarizer plate 20.

FIG. 4E is a cross-sectional view showing a step of bonding the second polarizer plate 20 to the counter substrate 200 in the method for producing the liquid crystal device 10 in embodiment 1 according to the present invention. As shown in FIG. 4E, the second polarizer plate 20 is bonded to the top surface of the counter substrate 200, namely, on the side opposite to the array substrate 100 with respect to the counter substrate 200, with an adhesive. In the case where the resin member 500 is to be formed also on the side surface of the second polarizer plate 20, the resin member 500 may be formed after the second polarizer plate 20 is bonded to the counter substrate 200. In order to avoid the resin member 500 from protruding above the second polarizer plate 20, it is preferable that the thickness of the resin member 500 is smaller than the total thickness of the second polarizer plate 20, the counter substrate 200 and the liquid crystal layer 170.

FIG. 4F is a cross-sectional view showing a step of peeling off the support substrate 105 from the array substrate 100 in the method for producing the liquid crystal device 10 in embodiment 1 according to the present invention. As shown in FIG. 4F, the components formed on the array substrate 100 and the components formed between the array substrate 100 and the counter substrate 200 are peeled off from the support substrate 105. As a result, the flexible liquid crystal display device 30 is provided. The above components may be peeled off as follows, for example. Laser light is directed toward a bottom surface of the support substrate 105 (on the side opposite to the counter substrate 200 with respect to the array substrate 100) to locally heat an interface between the support substrate 105 and the array substrate 100. Then, the first polarizer plate 40 and the backlight unit 50 are bonded, with an adhesive, to the bottom surface of the array substrate 100, from which the support substrate 105 has been peeled off. Thus, the liquid crystal display device 30 having the structure shown in FIG. 3 is formed.

### Embodiment 2

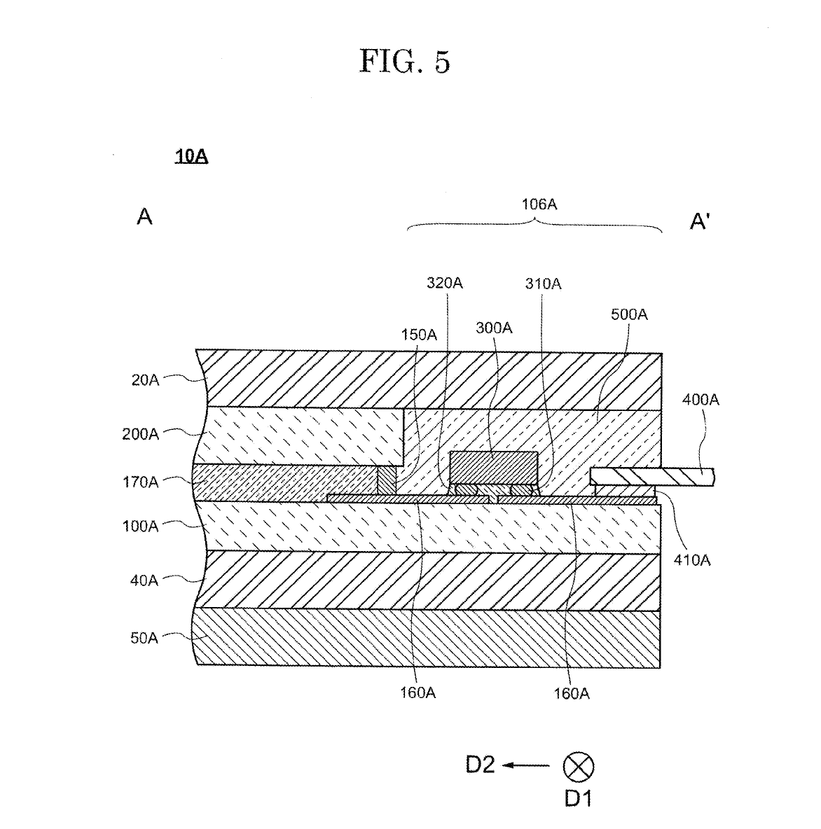

With reference to FIG. 5, an overview of a liquid crystal device in an embodiment according to the present invention will be described. A liquid crystal device 10A in embodiment 2 is similar to the liquid crystal device 10 in embodiment 1. Unlike in the liquid crystal device 10 in embodiment 1, in the liquid crystal device 10A in embodiment 2, an array substrate 100A in a driving region 106A is reinforced, on the side of a second polarizer plate 20A, by both of a resin member 500A and the second polarizer plate 20A. A planar layout of a liquid crystal display device 30A of the liquid crystal device 10A in embodiment 2 is the same as that of the liquid crystal display device 30 in embodiment 1, and thus will not be described here. In the following, the above-described difference of embodiment 2 from embodiment 1 will be described.

### [Cross-Sectional View of the Liquid Crystal Device 10A]

FIG. 5 is a cross-sectional view showing an overall structure of the liquid crystal device 10A in embodiment 2 according to the present invention. As shown in FIG. 5, the second polarizer plate 20A extends, beyond an end of a counter substrate 200A in the direction D2, to the driving region 106A. The second polarizer plate 20A has an end at a position that is approximately the same as the position of an end of the array substrate 100A and the position of an end of a first polarizer plate 40A. Namely, the second polarizer plate 20A has an area size larger than that of the counter substrate 200A as seen in a plan view. The second polarizer plate 20A overlaps terminal sections 160A, an IC chip 300A and a part of an FPC 400A in the driving region 106A. In other words, the first polarizer plate 40A and the second polarizer plate 20A hold the terminal sections 160A therebetween.

The resin member 500A is located between the array substrate 100A and the second polarizer plate 20A. The resin member 500A alleviates the steps formed by the components located in the driving region 106A, namely, the IC chip 300A, the FPC 400A and the like. The resin member 500A and the counter substrate 200A provide a surface having an alleviated step or a flat surface on which the second polarizer plate 20A is to be located. The resin member 500A retains a gap between the terminal sections 160A and the second polarizer plate 20A, a gap between the IC chip 300A and the second polarizer plate 20A, and a gap between the FPC 400A and the second polarizer plate 20A.

As described above, in the liquid crystal device 10A in embodiment 2, the array substrate 100A in the driving region 106A is reinforced, on the side of the second polarizer plate 20A, by the resin member 500A and the second polarizer plate 20A. Therefore, the liquid crystal device 10A is more highly reliable in terms of the load resistance characteristics than the liquid crystal device 10 in embodiment 1.

### Embodiment 3

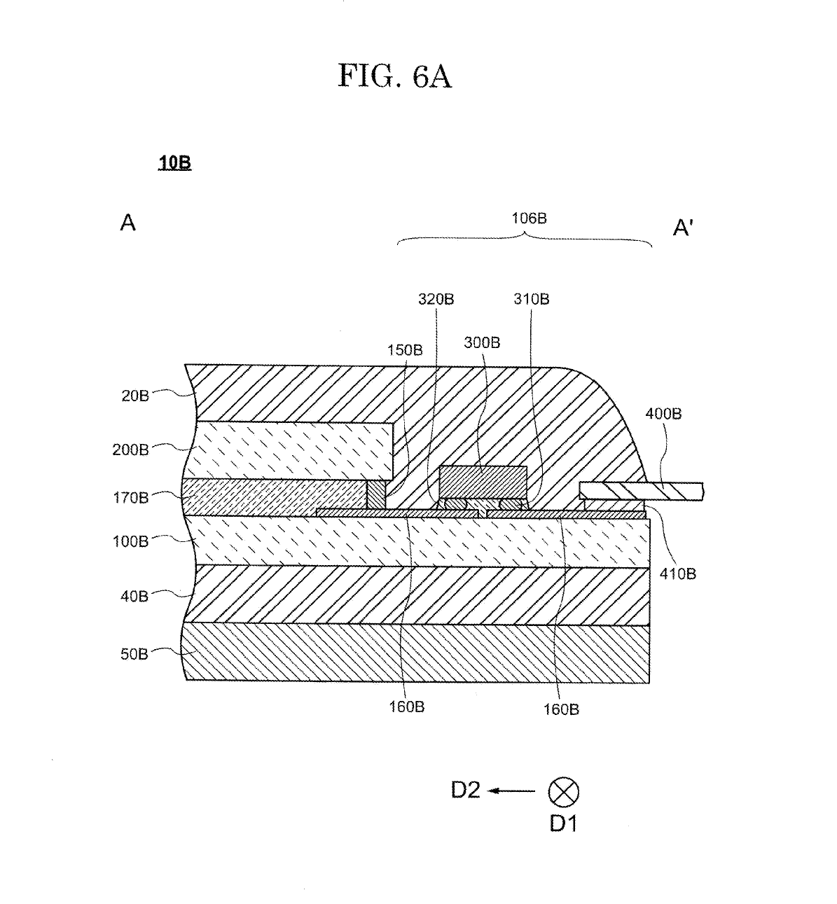

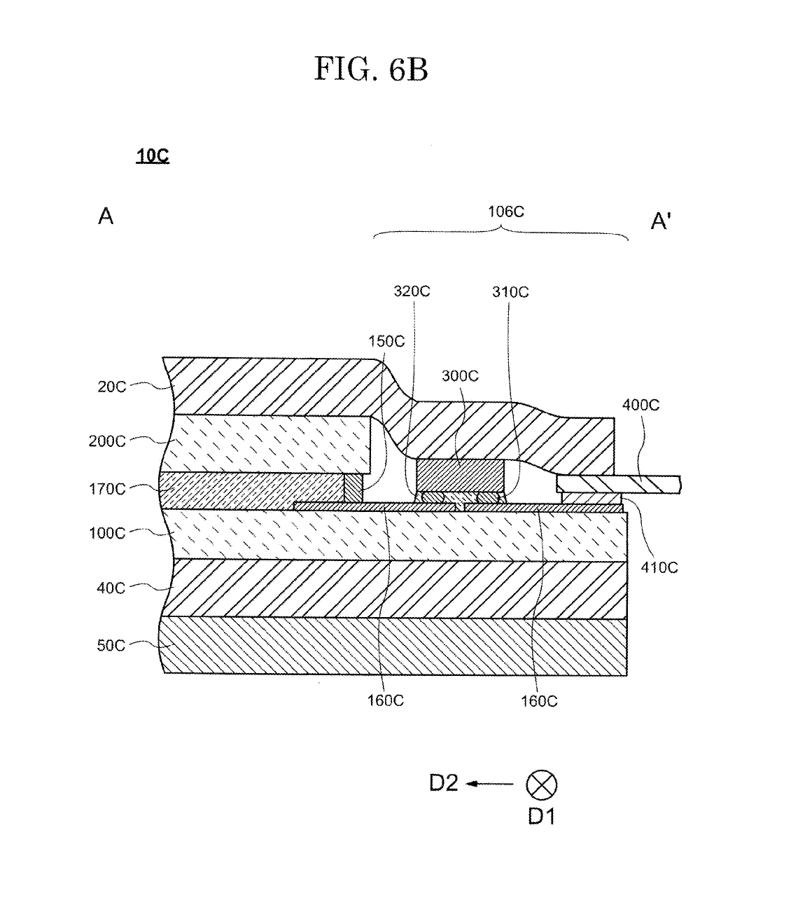

With reference to FIG. 6A and FIG. 6B, an overview of a liquid crystal display device in an embodiment according to the present invention will be described. A liquid crystal device 10B in embodiment 3 is similar to the liquid crystal device 10A in embodiment 2. Unlike in the liquid crystal device 10A in embodiment 2, in the liquid crystal device 10B in embodiment 3, an array substrate 100B in a driving region 106B is reinforced, on the side of a second polarizer plate 20B, by only the second polarizer plate 20B. A planar layout of a liquid crystal display device 30B of the liquid crystal device 10B in embodiment 3 is the same as that of the liquid crystal display device 30 in embodiment 1, and thus will not be described here. In the following, the above-described difference of embodiment 3 from embodiment 2 will be described.

### [Cross-Sectional View of the Liquid Crystal Device 10B]

FIG. 6A is a cross-sectional view showing an overall structure of the liquid crystal device 10B in embodiment 3 according to the present invention. As shown in FIG. 6A, the second polarizer plate 20B extends, beyond an end of a counter substrate 200B in the direction D2, to the driving region 106B. The second polarizer plate 20B covers, and is in contact with, a side surface of the counter substrate 200B, terminal sections 160B, an IC chip 300B, and a part of an FPC 400B. The second polarizer plate 20B has a thickness in the driving region 106B larger than that in a region thereof overlapping the counter substrate 200B. Unlike, for example, the sheet-like second polarizer plate 20A shown in FIG. 5, the second polarizer plate 20B shown in FIG. 6A is formed by application of a material. The second polarizer plate 20B formed by application has a rounded end portion having a curved top end. It should be noted that the top end of the end portion of the second polarizer plate 20B formed by application does not need to be curved.

In the example of FIG. 6A, the second polarizer plate 20B is located with no gap in the driving region 106B. The second polarizer plate 20B is not limited to having such a structure. The second polarizer plate 20B merely needs to be located continuously from the end of the counter substrate 200B to a part of the FPC 400B. For example, as in a liquid crystal device 100 shown in FIG. 6B, the second polarizer plate 20B may be replaced with a sheet-like second polarizer plate 20C, which extends from a top surface of a counter substrate 200C to a top surface of a part of an FPC 400C while being partially bent. In the example of FIG. 6B, the second polarizer plate 20C is bonded to the counter substrate 200C, an IC chip 300C, and the part of the FPC 400C. In the example of FIG. 6B, the second polarizer plate 20C is not in contact with terminal sections 160C. Alternatively, the second polarizer plate 20C may be in contact with the terminal sections 160C. In the example of FIG. 6B, no component is present and a space is formed between the terminal sections 160C and the second polarizer plate 20C. A resin member may be provided in this space.

As described above, respectively in the liquid crystal devices 10B and 10C in embodiment 3, the array substrates 100B and 100C in the driving regions 106B and 106C are reinforced, on the side of the second polarizer plates 20B and 20C, by the second polarizer plates 20B and 20C. Therefore, the liquid crystal devices 10B and 10C are highly reliable in terms of the load resistance characteristics.

### Embodiment 4

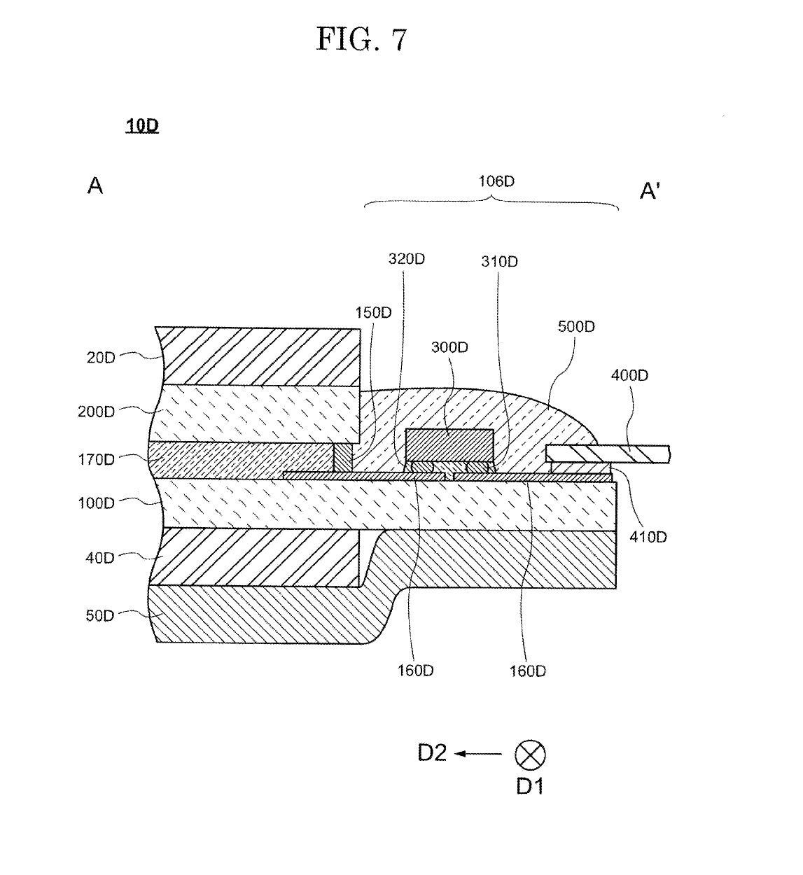

With reference to FIG. 7, an overview of a liquid crystal device in an embodiment according to the present invention will be described. A liquid crystal device 10D in embodiment 4 is similar to the liquid crystal device 10 in embodiment 1. Unlike in the liquid crystal device 10 in embodiment 1, in the liquid crystal device 10D in embodiment 4, an array substrate 100D in a driving region 106D is reinforced, on the side of a first polarizer plate 40D, by a backlight unit 50D instead of the first polarizer plate 40D. A planar layout of a liquid crystal display device 30D of the liquid crystal device 10D in embodiment 4 is the same as that of the liquid crystal display device 30 in embodiment 1, and thus will not be described here. In the following, the above-described difference of embodiment 4 from embodiment 1 will be described.

### [Cross-Sectional View of the Liquid Crystal Device 10D]

FIG. 7 is a cross-sectional view showing an overall structure of the liquid crystal device 10D in embodiment 4 according to the present invention. As shown in FIG. 7, the first polarizer plate 40D has an end thereof at a position that is approximately the same as the position of an end of a second polarizer plate 20D. The backlight unit 50D extends, beyond an end of the first polarizer plate 40D in the direction D2, to the driving region 106D and is bonded to the array substrate 100D. Namely, terminal sections 160D are held between the backlight unit 50D and a resin member 500D. Since the backlight unit 50D is included in the first optical member mentioned above, the terminal sections 160D may be expressed as being held between the first optical member and the resin member 500D. The backlight unit 50D in the driving region 106D merely needs to include either one of a light emission source, a light guide plate, a reflective sheet, a diffusive sheet and a prism sheet. For example, the backlight unit 50D in the driving region 106D may include only the light guide plate. In the example of FIG. 7, a space enclosed by the backlight unit 50D, the first polarizer plate 40D, and the array substrate 100D has no component provided therein and is left empty. A resin member may be provided in this space.

As described above, in the liquid crystal device 10D in embodiment 4, the array substrate 100D in the driving region 106D is reinforced, on the side of the first polarizer plate 40D, by the backlight unit 50D. Therefore, the liquid crystal device 10D is highly reliable in terms of the load resistance characteristics.

### Embodiment 5

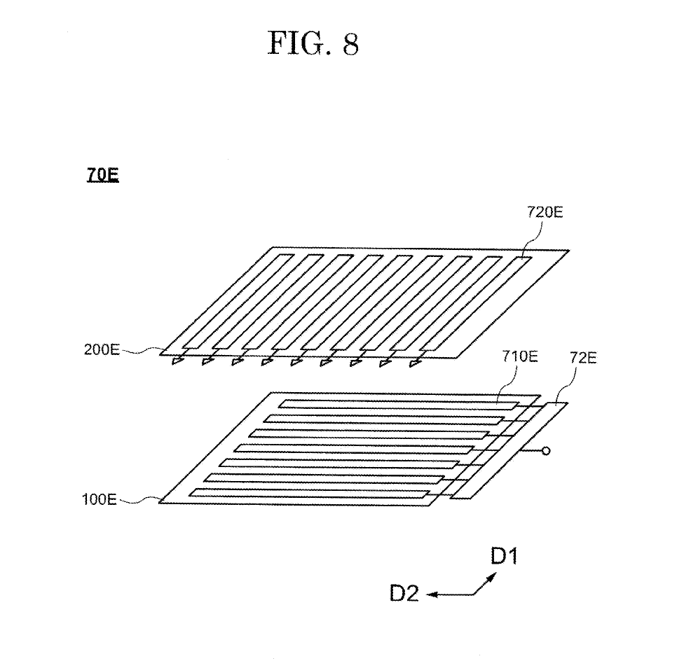

With reference to FIG. 8 through FIG. 10, a touch sensor-attached liquid crystal device in an embodiment according to the present invention will be described. A touch sensor-attached liquid crystal device 10E in embodiment 5 includes a driving region 106E having substantially the same structure as that of the driving region 106 in embodiment 1. For ease of explanation, the IC chip 300 shown in the figures regarding embodiment 1 is not shown. In the following, an overview of a structure of the touch sensor-attached liquid crystal device 10E will be first described.

### [Functional Structure of the Liquid Crystal Device 10E]

FIG. 8 is a general view of electrodes for a touch sensor of the touch sensor-attached liquid crystal device 10E of an electrostatic capacitance type in embodiment 5 according to the present invention. A touch sensor unit 70E is connected with, and is controlled by, a touch signal selector 72E and a touch driver (not shown). The touch sensor unit 70E includes a plurality of touch sensor driving electrodes (TX) 710E and a plurality of touch detection electrodes (RX) 720E. The touch sensor driving electrodes 710E are located on an array substrate 100E. The touch detection electrodes 720E are located on a counter substrate 200E. The touch sensor driving electrodes 710E have a longitudinal direction in a column direction (direction D2 in FIG. 8) and are arrayed side by side in a row direction (direction D1 in FIG. 8). The touch detection electrodes 720E have a longitudinal direction in the direction D1 and are arrayed side by side in the direction D2. The touch sensor driving electrodes 710E are controlled by the touch signal selector 72E and the touch driver.

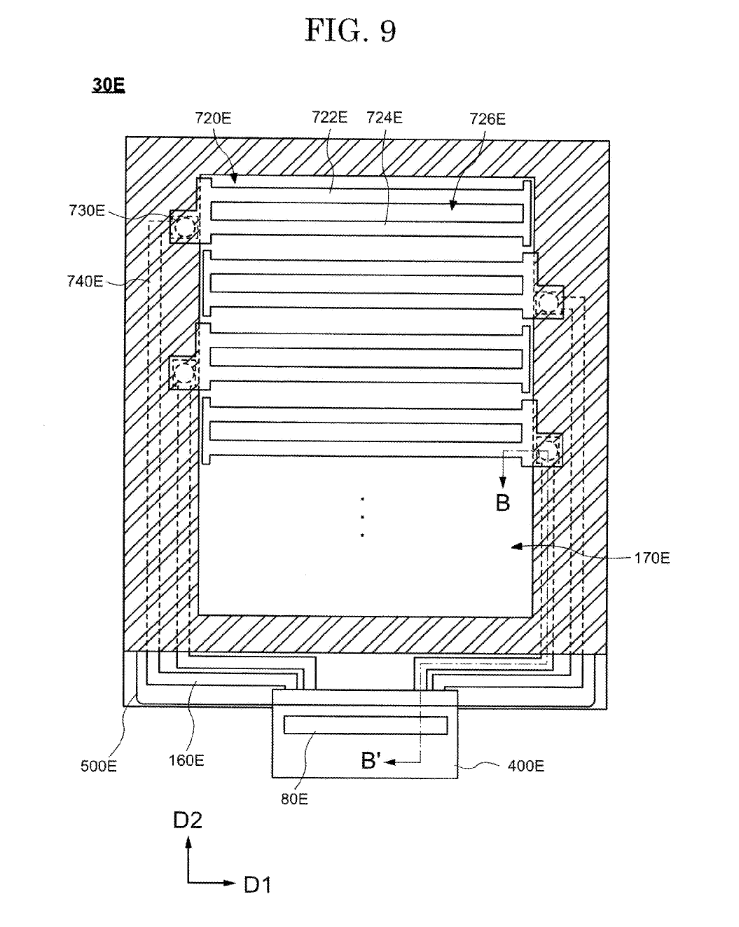

As shown in FIG. 9, a touch detection unit 80E located in an FPC 400E is connected with the touch sensor unit 70E. The touch detection unit 80E receives a touch detection signal output from the touch sensor unit 70E. The touch detection signal indicates that the touch sensor unit 70E has been touched with a detection target. Specifically, the touch detection unit 80E receives a touch detection signal via either one of the touch detection electrodes 720E. The touch detection unit 80E includes an analog LPF (Low Pass Filter) unit, an A/D (analog/digital) conversion unit, a signal processing unit, a coordinate extraction unit, a touch detection timing control unit and the like. The detection target may be a dielectric body such as, for example, a hand or a finger of a user using the liquid crystal device 10E. The detection target may be, for example, another dielectric body such as a stylus or the like.

The touch detection unit 80E detects whether the touch sensor unit 70E has been touched or not, based on a control signal supplied from the control unit and a touch detection signal supplied from the touch sensor unit 70E. When the touch sensor unit 70E is detected to have been touched, the touch detection unit 80E detects a coordinate position where the touch is detected. Two touch detection electrodes 720E adjacent to each other, among the plurality of touch detection electrodes 720E, are separated from each other. The plurality of touch detection electrodes 720E are electrically independent from each other, and therefore, are connected with a plurality of different output terminals from each other. The touch sensor included in the liquid crystal device 10E is of a mutual capacitance type, which detects a change in the capacitance value formed between one of the touch sensor driving electrodes 710E and the touch detection electrode 720E corresponding thereto, and thus detects whether the touch has been made or not.

### [Planar Layout of the Liquid Crystal Display Device 30E]

FIG. 9 is a plan view showing the planar layout of the touch detection electrodes 720E in the touch sensor-attached liquid crystal device 10E in embodiment 5 according to the present invention. For ease of explanation, FIG. 9 shows the liquid crystal display device 30E and does not show the optical members such as a first polarizer plate 40E, a second polarizer plate 20E, a backlight unit 50E and the like. In FIG. 9, a sealing member 150E is located in the hatched region. A region surrounded by the sealing member 150E is a liquid crystal layer 170E.

As shown in FIG. 9, the touch detection electrodes 720E are located in the region surrounded by the sealing member 150E, and have a longitudinal direction in the direction D1. Namely, the touch detection electrodes 720E are located in a region overlapping the liquid crystal layer 170E. A part of the touch detection electrodes 720E overlaps the sealing member 150E. The touch detection electrodes 720E each include a first electrode portion 722E, a second electrode portion 724E, and a hollow portion 726E. The first electrode portion 722E and the second electrode portion 724E both have a longitudinal direction in the direction D1, and are coupled together at both of two ends thereof. The hollow portion 726E is surrounded by the first electrode portion 722E and the second electrode portion 724E.

The touch detection electrodes 720E are respectively connected with lines 740E via through-holes 730E. The through-hole 730E is provided in a region where each of the touch detection electrodes 720E overlaps the sealing member 150E. As described below in detail, the through-hole 730E runs at least from a top surface of the counter substrate 200E to a bottom surface of the sealing member 150E. The lines 740E pass a region overlapping the sealing member 150E and are connected with terminal sections 160E. A section of the terminal sections 160E that is exposed from the sealing member 150E overlaps a resin member 500E.

### [Cross-Sectional View of the Liquid Crystal Display Device 30E]

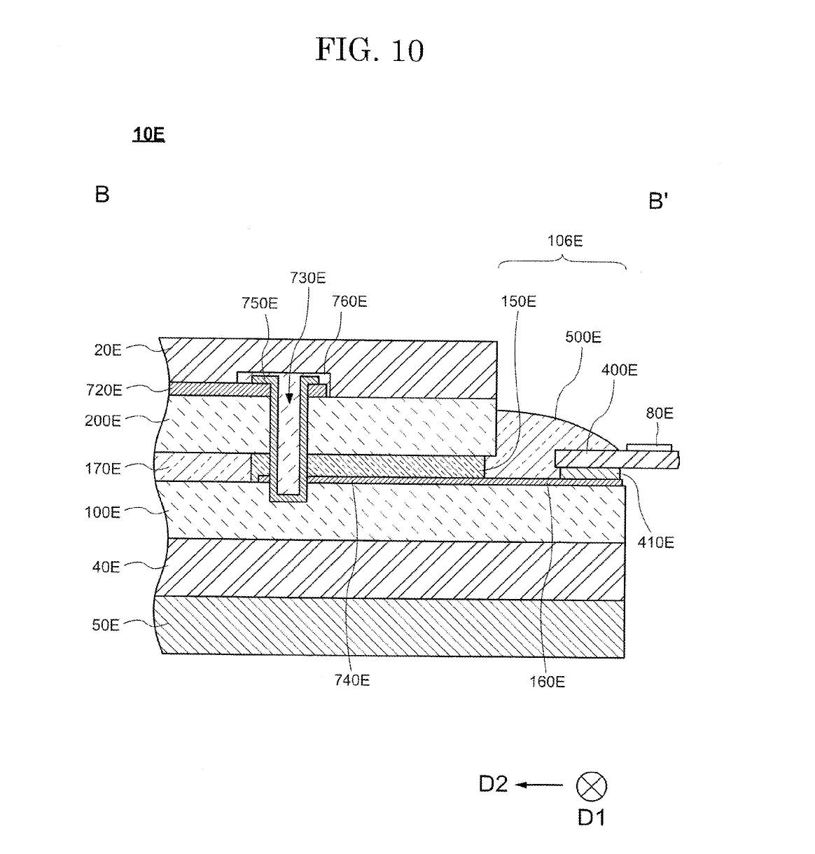

FIG. 10 is a cross-sectional view of the touch sensor-attached liquid crystal device 10E in embodiment 5 according to the present invention, taken along line B-B′ in FIG. 9. The structure of the driving region 106E in FIG. 10 is substantially the same as that of the driving region 106 in FIG. 3 although the IC chip 300 is not shown, and will not be described here. As shown in FIG. 10, the line 740E is located between the array substrate 100E and the sealing member 150E. The touch detection electrode 720E is located on the counter substrate 200E. Namely, the touch detection electrode 720E is located on a surface of the counter substrate 200E opposite to a surface thereof facing the array substrate 100E. The line 740E is connected with the terminal section 160E located in the driving region 106E. The through-hole 730E runs through the touch detection electrode 720E, the counter substrate 200E, the sealing member 150E, and the line 740E, and forms a recessed portion in the array substrate 100E.

A run-through electrode 750E is located inside the through-hole 730E. The run-through electrode 750E is in contact with a top surface of the touch detection electrode 720E, a side wall of the touch detection electrode 720E that is exposed inside the through-hole 730E, and a side wall of the line 740E that is exposed inside the through-hole 730E. Namely, the run-through electrode 750E electrically connects the touch detection electrode 720E and the line 740E to each other. Inside the through-hole 730E, a region inner to the run-through electrode 750E is filled with a filler 760E. A resin material is used as the filler 760E. The resin material used as the filler 760E may be insulating or conductive.

Now, a method for forming the through-hole 730E will be described. The counter substrate 200E having the touch detection electrode 720E formed thereon is bonded with the array substrate 100E with the sealing member 150E. After the counter substrate 200E and the array substrate 100E are bonded to each other, laser light is directed to a region of the resultant assembly in which the run-through hole 730E is to be formed, from the side of the counter substrate 200E. By the energy of the laser light, the run-through hole 730E reaching the array substrate 100E is formed. In the example of FIG. 10, side walls of the touch detection electrode 720E, the counter substrate 200E, the sealing member 150E, the line 740E and the array substrate 100E that are exposed in the through-hole 730E are linearly continuous. The liquid crystal device 10E is not limited to having such a structure. For example, the sealing member 150E may be retracted, in a direction in which the through-hole 730E is expanded, from the counter substrate 200E and the line 740E. Namely, a top surface of the line 740E may be exposed from the sealing member 150E. The sealing member 150E is formed of a resin material, and thus is more easily sublimed by optical energy than the counter substrate 200E and the line 740E. Therefore, the sealing member 150E may be retracted as described above.

As described above, in the touch sensor-attached liquid crystal device 10E in embodiment 5, each of the touch detection electrodes 720E located on the counter substrate 200E and the corresponding line 740E located on the array substrate 100E are connected with each other by a connection portion located in the sealing member 150E. Therefore, the line 740E connected with the terminal section 160E is located to overlap the sealing member 150E. Because of this structure, it is not necessary to form the connection portion in a region protruding from the counter substrate by use of a conductive paste, a conductive sheet or the like, which is necessary by the conventional technology. This allows the driving region 106E to be smaller, and thus allows a majority of the driving region 106E to be covered with the resin member 500E. It is not necessary to separately provide an FPC for the touch detection electrode 720E located on the counter substrate 200E, which simplifies the structure of the liquid crystal device 10E.

In embodiment 5, the conductive layer located on the counter substrate 200E is the touch detection electrode 720E. The liquid crystal device 10E is not limited to having such a structure. The conductive layer located on the counter substrate 200E may be any other electrode than the touch detection electrode 720E. For example, a conductive layer protecting the liquid crystal device 10E against external electrostatic charges may be provided. In embodiment 5, the structure of the driving region 106E is substantially the same as that of the driving region 106 in embodiment 1 shown in FIG. 3. Alternatively, the driving region 106E may have, for example, the structure of any of the driving regions 106A through 106D shown in FIG. 5, FIG. 6A, FIG. 6B and FIG. 7.

### Embodiment 6

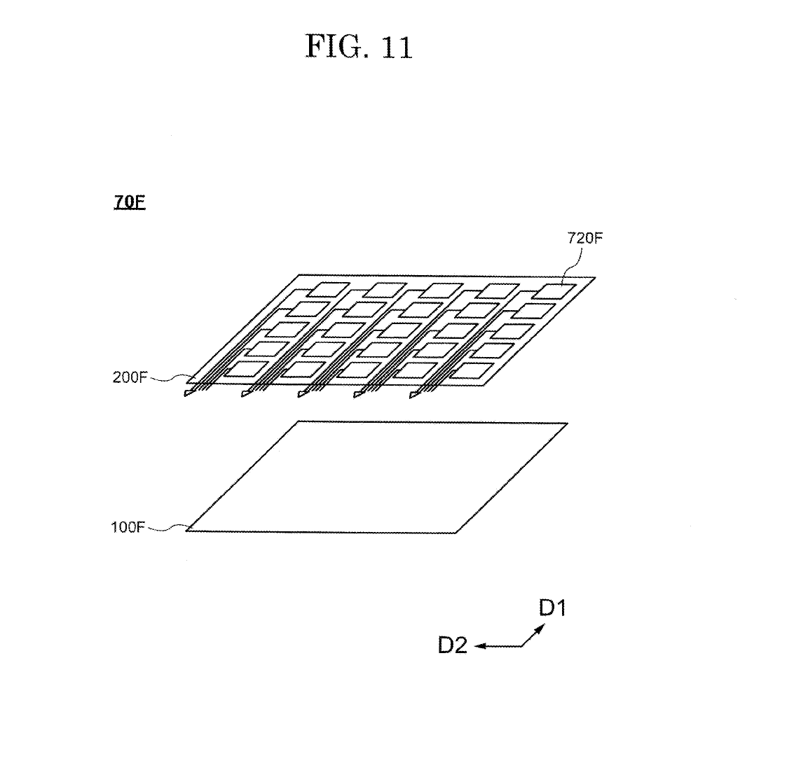

With reference to FIG. 11, an overview of a touch sensor-attached liquid crystal device in an embodiment according to the present invention will be described. A touch sensor unit 70F of a touch sensor-attached liquid crystal device 10F in embodiment 6 is similar to the touch sensor unit 70E of the liquid crystal device 10E in embodiment 5 shown in FIG. 8, but the electrodes provided on an array substrate 100F and a counter substrate 200F have different planar shapes from those of the touch sensor unit 70E of the liquid crystal device 10E.

As shown in FIG. 11, the touch sensor unit 70F includes touch detection electrodes 720F. The touch detection electrodes 720F are located on the counter substrate 200F. The touch sensor unit 70F is of a self-capacitance type, which detects a change in the capacitance value formed between one of the touch detection electrodes 720F and a detection target, and thus detects whether the touch has been made or not. The touch detection electrodes 720F are located in a matrix in a touch sensor region. A touch common electrode provided on the array substrate 100F is supplied with a voltage common to the plurality of pixels. The touch detection electrodes 720F each output a touch detection signal to a touch detection unit 80F. The touch detection unit 80F detects a change in the capacitance value of each of the touch detection electrodes 720F, and thus detects a coordinate position where the touch has been made.

As in the touch sensor-attached liquid crystal device 10F in embodiment 6, various shape of electrodes may be used as electrodes for the touch sensor.

### Embodiment 7

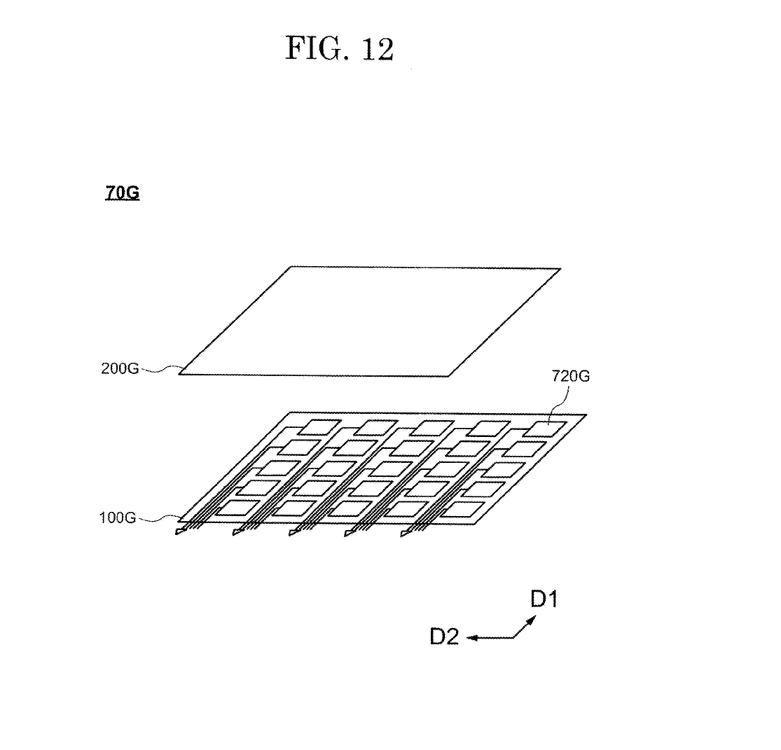

With reference to FIG. 12, a touch sensor-attached liquid crystal device in an embodiment according to the present invention will be described. A touch sensor unit 70G of a touch sensor-attached liquid crystal device 10G in embodiment 7 is similar to the touch sensor unit 70F of the liquid crystal device 10F in embodiment 6 shown in FIG. 11. Unlike in the liquid crystal device 10F, in the liquid crystal device 10G, touch detection electrodes 720G arrayed in a matrix are provided on an array substrate 100G, and no electrode for the touch sensor is provided on a counter substrate 200G.

The touch detection electrodes 720G include transistors, lines and an insulating layer that insulates the lines from each other. The transistors, the lines and the insulating layer are located on the array substrate 100G. For example, the touch detection electrodes 720G may each be formed of a layer used to form either one of a pair of electrodes provided to form an electric field in a liquid crystal layer 170G. In this case, the touch detection electrodes 720G are located in a region overlapping the liquid crystal layer 170G.

As in the touch sensor-attached liquid crystal device 10G in embodiment 7, various shape of electrodes may be used as electrodes for the touch sensor. The structure of this embodiment is applicable to any touch sensor of a mutual capacitance type or a self capacitance type. In this embodiment, no touch detection electrode is provided on the counter substrate 200G. Therefore, it is not necessary to connect electrodes on a counter substrate and lines on an array substrate to each other by use of a conductive paste, a conductive sheet or the like, which is necessary by the conventional technology. This allows a driving region to be smaller, and thus allows a majority of a driving region to be covered with a resin member.

### Embodiment 8

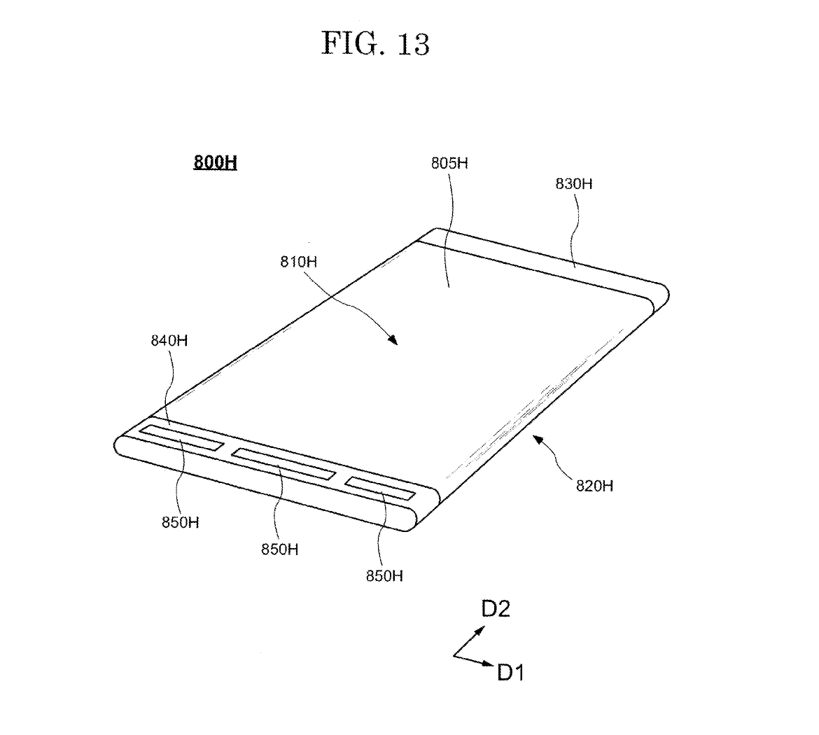

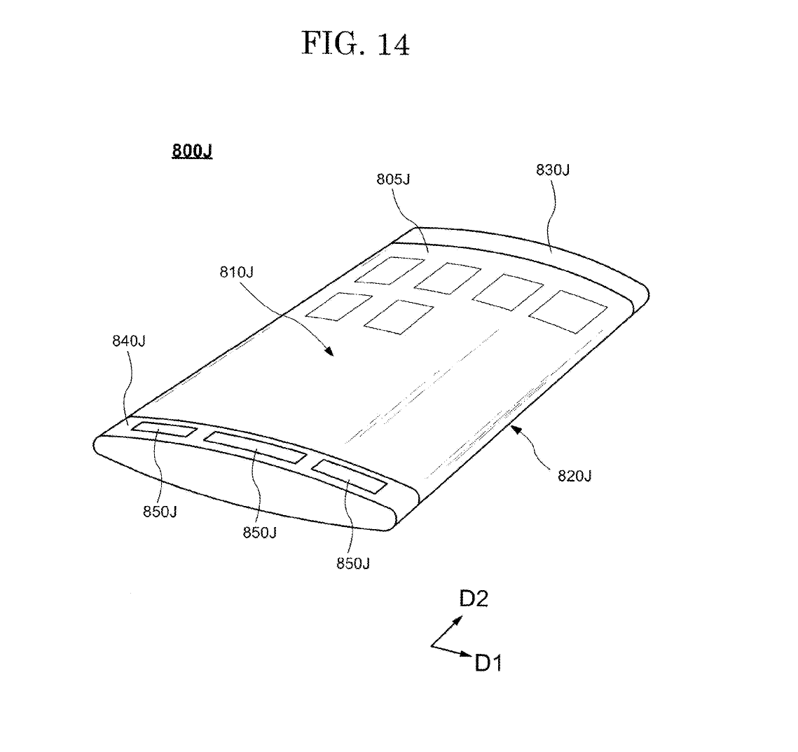

With reference to each of FIG. 13 and FIG. 14, an example of electronic device including a liquid crystal device described above in each of the embodiments will be described. FIG. 13 and FIG. 14 each show an example of electronic device including a liquid crystal device in an embodiment according to the present invention. The electronic device shown in FIG. 13 is a smartphone 800H. The smartphone 800H includes a display section 805H, a top frame section 830H, a bottom frame section 840H, and operation buttons 850H. The display section 805H is flat in a central section 810H. In end regions 820H, the display section 805H is curved and bent toward a rear surface. In the end regions 820H, no optical member corresponding to the first polarizer plate 40, the second polarizer plate 20 or the backlight unit 50 shown in, for example, FIG. 3 is provided, and an array substrate, a counter substrate and components provided between the array substrate and the counter substrate are bent. Frame regions at both of two ends in the direction D1 are bent toward the rear surface. Therefore, in the case where a user looks at the display section 805H from the front, the frames in the end regions 820H at both of the two ends in the direction D1 are not visually recognized by the user. In the example of FIG. 13, the end regions 820H at both of the two ends in the direction D1 are bent. The smartphone 800H is not limited to having such a structure. For example, the top frame section 830H may be bent, or alternatively, the end regions 820H at both of the two ends in the direction D1 and the top frame section 830H may be bent.

A smartphone 800J shown in FIG. 14 is similar to the smartphone 800H shown in FIG. 13. Unlike in the smartphone 800H, in the smartphone 800J, a display section 805J is curved in the direction D1 in a central section 810J. In the central section 810J, a first polarizer plate 40J, a second polarizer plate 20J and a backlight 50j are located.

FIG. 13 and FIG. 14 each show a smartphone as an example of electronic device. A liquid crystal device in an embodiment according to the present invention is applicable to a mobile phone, a tablet PC, a PDA (Personal Digital Assistant), a notebook PC, a PHS (Personal Handyphone System), a car navigation system, and the like in addition to the smartphone.

The present invention is not limited to any of the above-described embodiments, and may be appropriately altered without departing from the gist of the present invention.

What is claimed is:

1. A display device, comprising:
a flexible first substrate;
a flexible second substrate facing the first substrate;
a liquid crystal layer between the first substrate and the second substrate;
a sealing member sealing the liquid crystal layer between the first substrate and the second substrate;
a first optical member bonded to the first substrate;
a terminal section on the first substrate, the terminal section being in a region not overlapping the second substrate;
a driving circuit substrate connected with the terminal section; and
a second optical member or a resin member, the terminal section being between the first optical member and the second optical member or between the first optical member and the resin member.

2. The display device according to claim 1, wherein neither the first substrate nor the second substrate includes a glass substrate.

3. The display device according to claim 1, wherein:
the display device includes the second optical member, the second optical member is bonded to the second substrate, and the terminal section is between the first optical member and the second optical member; and
the sealing member entirely overlaps the first optical member and the second optical member.

4. The display device according to claim 1, wherein:
the display device includes the resin member, and the terminal section is between the first optical member and the resin member; and
the terminal section overlaps the first optical member and the resin member.

5. The display device according to claim 1, wherein:
the display device includes the second optical member, the second optical member is bonded to the second substrate, and the terminal section is between the first optical member and the second optical member; and
the terminal section overlaps the first optical member and the second optical member.

6. The display device according to claim 1, wherein:
the display device includes the second optical member, the second optical member is bonded to the second substrate, and the terminal section is between the first optical member and the second optical member; and
the second optical member has an area size larger than an area size of the second substrate in a plan view.

7. The display device according to claim 1, further comprising a conductive layer on a side opposite to a side of the first substrate with respect to the second substrate;
wherein the conductive layer is electrically connected with the terminal section via a through-hole in the second substrate and the sealing member.

8. The display device according to claim 1, further comprising a touch detection electrode on a region of the first substrate, the region overlapping with the liquid crystal layer in a plan view, the touch detection electrode being supplied with a touch detection signal.

9. The display device according to claim 1, wherein:
the display device includes the second optical member, the second optical member is bonded to the second substrate, and the terminal section is between the first optical member and the second optical member; and
the first optical member and the second optical member are each a polarizer plate.

10. The display device according to claim 1, wherein the first optical member is a backlight unit.

11. The display device according to claim 10, wherein:
the display device includes the second optical member, the second optical member is bonded to the second substrate, and the terminal section is between the first optical member and the second optical member; and
the first optical member is a light guide plate.

12. The display device according to claim 2, wherein:
the display device includes the second optical member, the second optical member is bonded to the second substrate, and the terminal section is between the first optical member and the second optical member; and
the sealing member entirely overlaps the first optical member and the second optical member.

13. The display device according to claim 12, wherein the terminal section overlaps the first optical member and the second optical member.

14. The display device according to claim 13, wherein the second optical member has an area size larger than an area size of the second substrate in a plan view.

15. The display device according to claim 14, further comprising a conductive layer on a side opposite to a side of the first substrate with respect to the second substrate;
wherein the conductive layer is electrically connected with the terminal section via a through-hole in the second substrate and the sealing member.

16. The display device according to claim 15, further comprising a touch detection electrode on a region of the first substrate, the region overlapping with the liquid crystal layer in a plan view, the touch detection electrode being supplied with a touch detection signal.

17. The display device according to claim 16, wherein the first optical member and the second optical member are each a polarizer plate.

18. The display device according to claim 17, wherein the first optical member is a backlight unit.

19. The display device according to claim 18, wherein the first optical member is a light guide plate.

20. The display device according to claim 2, wherein:
the display device includes the resin member, and the terminal section is between the first optical member and the resin member; and
the terminal section overlaps the first optical member and the resin member.
